(19) United States
(12) Patent Application Publication
(10) Pub. No.: US 2011/0072811 A1
(43) Pub. Date: Mar. 31, 2011

(54) ENGINE DRIVEN LIFT GATE POWER SYSTEM

(75) Inventor: Paul Bark, Canyon Lake, CA (US)

(73) Assignee: RS Drawings, LLC, Santa Fe Springs, CA (US)

(21) Appl. No.: 12/570,812

(22) Filed: Sep. 30, 2009

(51) Int. Cl. F16D 31/02

(52) U.S. Cl. 60/459

(57) ABSTRACT

A power system for a lift gate is provided. The power system includes an actuator system including an actuator for a lift gate, and a lift gate engine coupled to the actuator system. The lift gate engine is configured for generating kinetic energy from a fuel source to power the actuator system for operating the lift gate.

### BACKGROUND OF THE INVENTION

1. Field of the Invention

The present invention relates generally to lift gates, and in particular, to a system for powering lift gates.

2. Description of Related Art

Lifts such as lift gates are typically mounted at a structure such as the rear of a vehicle to lift payloads on a platform from one level (e.g., ground level) up to another level (e.g., the bed of the vehicle), or vice versa.

One type of lift gate employs linkages to maintain the lift platform in a horizontal plane through the lifting range. The lift platform is attached to linkages by pivot members, which allow the lift platform to be pivoted. Operation of the lifting mechanism may also rotate the lift platform into an inverted, stowed position beneath the vehicle body. Hydraulic actuators and electric actuators are used to provide lifting force for moving the lift.

Electrical power to electric motors for such actuators is provided by batteries. The batteries are charged/recharged by an alternator that is coupled to the vehicle engine to convert mechanical energy from the running vehicle engine to electrical energy.

In between recharges from the vehicle engine alternator, the batteries are used to provide electrical energy to the actuators in repeated cycles of lift operations. This drains the batteries to low voltages (e.g., below stated charge acceptable to run an electrical motor), causing problems with the electric solenoids and pump electric motors used in the actuators. Low battery voltage leads to inefficiencies and premature failures. The electric actuator motors run hot when voltage is low. Further, electric motors that energize hydraulic pumps run slower due to low battery voltage, slowing operation of the lift.

Further, the batteries require frequent running of the vehicle engine to recharge them. The vehicle engines are large, and designed to move an entire vehicle and its load. Idling the vehicle engine to recharge the batteries consumes extra fuel, causes wear on the engine, pollutes the environment, etc. In many areas where local laws prevent engine idling, the batteries cannot be recharged by idling the vehicle engine. There is often insufficient time between uses of the lift gate to fully recharge the batteries. Battery charging is time consuming.

Conventional approaches to address such problems involve using a charging device in addition to the vehicle engine alternator, to charge the batteries that energize the lift actuators. However, the batteries continue to run down on high cycle uses of the lift, requiring recharging. Further, such additional charging devices require long wiring between various electrical components, causing large voltage drops and energy waste.

### BRIEF SUMMARY OF THE INVENTION

A power system for a lift gate is provided. In one embodiment, the power system includes an actuator system including an actuator for a lift gate, and a lift gate engine coupled to the actuator system. The lift gate engine is configured for generating kinetic energy from a fuel source to power the actuator system for operating the lift gate.

The actuator may comprise a hydraulic actuator and the actuator system may further include a hydraulic pump for pumping hydraulic fluid to the hydraulic actuator. The lift gate engine is coupled to the hydraulic pump for directly driving the hydraulic pump to pump hydraulic fluid to the hydraulic actuator for operating the lift gate. The lift gate may comprise a platform coupled to a support frame via a lift linkage, the platform capable of being moved by the actuator via the lift linkage.

The power system may further include a controller module configured for monitoring a condition, and based on the condition controlling at least one of: the lift gate engine and the actuator system for operating the lift gate. The controller may further comprise a feedback loop configured for dynamically monitoring the lift gate engine and generating a signal to control the operation of the lift gate engine for operation of the lift gate. The controller module may further be configured for dynamically monitoring the actuator system and the lift gate engine to generate a signal for controlling operation of the lift gate engine. In so doing, the actuator system operation satisfies a predefined condition.

The power may further comprise a sensor system including an engine sensor for sensing operation of the lift gate engine. The controller is further configured for receiving engine sensor information and generating a control signal to maintain the lift gate engine within an operation range in powering the actuator system for proper operation of the actuator system for the lift gate.

The sensor system may further comprise an actuator sensor for sensing operation of the actuator system. The controller is further configured for receiving actuator sensor information and generating a control signal to the lift gate engine for maintaining the actuator system within an operation range for proper operation of the lift gate.

The sensor system may further comprise a lift gate sensor for sensing status of the lift gate. The controller is further configured for receiving lift gate sensor information and generating a control signal for proper operation of the lift gate to at least one of the following: the lift gate engine, the actuator system, the lift gate control module.

In another embodiment, the invention provides a lift gate system, comprising a lift gate, an actuator system including an actuator for the lift gate, and a lift gate engine coupled to the actuator system. The lift gate engine is configured for generating kinetic energy from a fuel source to power the actuator system for operating the lift gate. The lift gate system may further include a sensor system for sensing status of the system, a controller module configured for monitoring sensed status, and a lift gate engine or the actuator system for operating the lift gate depending on the sensed status.

The controller module may further be configured for dynamically monitoring sensed status of the actuator system and the lift gate engine, and generating a signal for controlling operation of the lift gate engine such that the actuator system operation satisfies a predefined condition.

The sensor system may include an engine sensor for sensing operation status of the lift gate engine, an actuator sensor for sensing operation status of the actuator system, and a lift gate sensor for sensing status of the lift gate. The controller may further be configured for receiving engine sensor information and generating a control signal to maintain the lift gate engine within an operation range in powering the actuator system for proper operation of the actuator system for the lift gate. The controller may further be configured for receiving actuator sensor information and generating a control signal to the lift gate engine for maintaining the actuator system within an operation range for proper operation of the lift gate. The controller may further be configured for receiving lift gate sensor information and generating a control signal to at least one of the following: the lift gate engine, the actuator system, the lift gate control module, for proper operation of the lift gate.

The controller module may further be configured for dynamically monitoring sensed hydraulic fluid pressure in the actuator system and sensed engine speed of the lift gate engine, and generating a signal for controlling operation of the lift gate engine such that hydraulic fluid pressure in the actuator system operation satisfies a predefined condition. The lift gate engine comprises an internal combustion engine.

In another embodiment, the invention provides a method of powering a lift gate by providing an actuator system including an actuator for a lift gate, and coupling a lift gate engine to the actuator system, wherein the lift gate engine is configured for generating kinetic energy from a fuel source to power the actuator system for operating the lift gate.

The lift gate may comprise a platform coupled to a support frame via a lift linkage, the platform capable of being moved by the actuator via the lift linkage. The method may further comprise dynamically sensing status of at least one of the following: the lift gate engine, the actuator system and the lift gate, a dynamically monitoring sensed status, and at least one of the following based on the sensed status controlling: the lift gate engine, the actuator system for operating the lift gate.

Controlling at least one of the following: the lift gate engine and the actuator system for operating the lift gate, may further comprise: if the lift gate engine is not running, then starting the lift gate engine using a starter; based on the sensed status, check if conditions for proper operation of the lift gate are satisfied; if the conditions are satisfied, then allowing operation of the lift gate; and monitoring the actuator system, and controlling lift gate engine RPM to maintain the actuator system in an operating range for proper operations of the lift gate.

The actuator may comprise a hydraulic actuator and the actuator system further includes a hydraulic pump for pumping hydraulic fluid to the hydraulic actuator, wherein coupling a lift gate engine to the actuator system further includes coupling the lift gate engine to the hydraulic pump for directly driving the hydraulic pump to pump hydraulic fluid to the hydraulic actuator for operating the lift gate.

The method may further comprise monitoring hydraulic fluid pressure in the actuator system, and controlling the lift gate engine RPM to maintain the hydraulic fluid pressure actuator system in a range for proper operations of the lift gate.

The method may further comprise dynamically monitoring sensed hydraulic fluid pressure in the actuator system and upon the hydraulic fluid pressure in the actuator system reaching a predefined level, generating a signal for opening a valve in the actuator system to allow hydraulic fluid to flow to the hydraulic actuator for moving the lift gate linkage.

These and other features, aspects and advantages of the present invention will become understood with reference to the following description, appended claims and accompanying figures.

### BRIEF DESCRIPTION OF THE DRAWINGS

FIG. 1 shows a functional block diagram of a system for powering a lift gate, according to an embodiment of the invention.

FIG. 2 shows a functional block diagram of a lift gate and power system for powering a lift gate, according to an embodiment of the invention.

FIG. 3 shows a more detailed functional block diagram of a lift gate and power system for powering a lift gate, according to an embodiment of the invention.

FIG. 4 shows a flowchart of a process for powering a lift gate using a power system, according to an embodiment of the invention.

FIG. 5 shows an example schematic of a lift gate and power system, according to an embodiment of the invention.

FIG. 6 shows a flowchart of a process for lift gate power system, and lift gate operation, according to an embodiment of the invention.

### DETAILED DESCRIPTION OF THE INVENTION

The following description is made for the purpose of illustrating the general principles of the invention and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

In one embodiment, the power system includes an actuator system including an actuator for a lift gate, and a lift gate engine coupled to the actuator system. The lift gate engine is configured for generating kinetic energy from a fuel source to power the actuator system for operating the lift gate.

The actuator may comprise a hydraulic actuator and the actuator system may further include a hydraulic pump for pumping hydraulic fluid to the hydraulic actuator. The lift gate engine is coupled to the hydraulic pump for directly driving the hydraulic pump to pump hydraulic fluid to the hydraulic actuator for operating the lift gate. The lift gate may comprise a platform coupled to a support frame via a lift linkage, the platform capable of being moved by the actuator via the lift linkage.

The power system may further include a controller module configured for monitoring a condition, and based on the condition controlling at least one of: the lift gate engine and the actuator system for operating the lift gate. The controller may further comprise a feedback loop configured for dynamically monitoring the lift gate engine and generating a signal to control the operation of the lift gate engine for operation of the lift gate. The controller module may further be configured for dynamically monitoring the actuator system and the lift gate engine, and generating a signal for controlling operation of the lift gate engine such that the actuator system operation satisfies a predefined condition.

The power may further comprise a sensor system including an engine sensor for sensing operation of the lift gate engine. The controller is further configured for receiving engine sensor information and generating a control signal to maintain the lift gate engine within an operation range in powering the actuator system for proper operation of the actuator system for the lift gate.

The sensor system may further comprise an actuator sensor for sensing operation of the actuator system. The controller is further configured for receiving actuator sensor information and generating a control signal to the lift gate engine for maintaining the actuator system within an operation range for proper operation of the lift gate.

The sensor system may further comprise a lift gate sensor for sensing status of the lift gate. The controller is further configured for receiving lift gate sensor information and generating a control signal to at least one of: the lift gate engine, the actuator system and a lift gate control module, for proper operation of the lift gate.

In another embodiment, the invention provides a lift gate system, comprising a lift gate, an actuator system including an actuator for the lift gate, and a lift gate engine coupled to the actuator system. The lift gate engine is configured for generating kinetic energy from a fuel source to power the actuator system for operating the lift gate. The lift gate system may further include a sensor system for sensing status of the system, and a controller module configured for monitoring sensed status, and based on the sensed status controlling at least one of: the lift gate engine and the actuator system for operating the lift gate.

The controller module may further be configured for dynamically monitoring sensed status of the actuator system and the lift gate engine, and generating a signal for controlling operation of the lift gate engine such that the actuator system operation satisfies a predefined condition.

The sensor system includes an engine sensor for sensing operation status of the lift gate engine, an actuator sensor for sensing operation status of the actuator system, and a lift gate sensor for sensing status of the lift gate. The controller may further be configured for receiving engine sensor information and generating a control signal to maintain the lift gate engine within an operation range in powering the actuator system for proper operation of the actuator system for the lift gate. The controller may further be configured for receiving actuator sensor information and generating a control signal to the lift gate engine for maintaining the actuator system within an operation range for proper operation of the lift gate. The controller may further be configured for receiving lift gate sensor information and generating a control signal to at least one of: the lift gate engine, the actuator system and a lift gate control module, for proper operation of the lift gate.

The controller module may further be configured for dynamically monitoring sensed hydraulic fluid pressure in the actuator system and sensed engine speed of the lift gate engine, and generating a signal for controlling operation of the lift gate engine such that hydraulic fluid pressure in the actuator system operation satisfies a predefined condition. The lift gate engine comprises an internal combustion engine.

Although the power system herein is described in relation to an example lift gate, the invention is also useful for powering other types of lift gates, and powering other systems such as wheel chair lifts and other systems that use actuation systems.

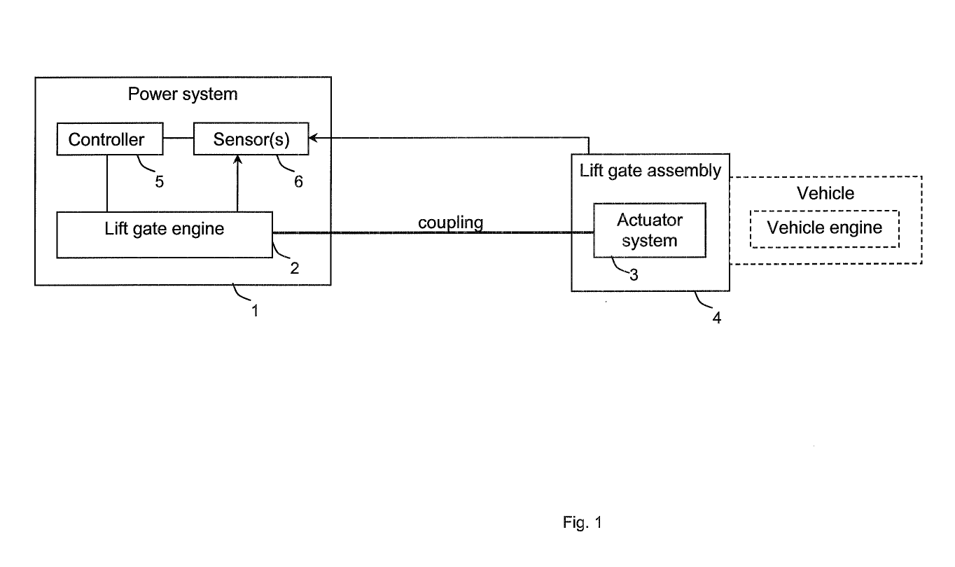

Referring to the example functional block diagram in FIG. 1, one embodiment of the invention comprises a power system 1 including a lift gate engine 2 that directly powers a lift gate actuator system 3 of a lift gate assembly 4. The power system 1 further includes a controller 5 and one or more sensors 6, wherein using information from the sensors 6 (and other sources as needed), the controller 5 controls operation of the lift gate engine 2 in providing power to the actuator system 3. The power system 1 alleviates the need for batteries to power the actuator system 3.

In one example, the lift gate engine is coupled to a hydraulic pump of an actuator for powering the pump for moving hydraulic fluid to operate a lift gate. The coupling may comprise, for example, a mechanical coupling, a viscous coupling, etc.

The lift gate engine is preferably a small engine such as a known small displacement internal combustion engine (e.g., gasoline, diesel). The lift gate engine is operable independent of the vehicle engine, and is of substantially lower displacement than the vehicle engine. For example the lift gate engine can comprise about a 2 to 10 horse power engine (e.g., single-cylinder 2-stroke air-cooled gasoline engine, displacement of 42.7 cc, bore and stroke of 40×34 mm and speed up to 6,500 rpm). Generally, the horse power required for the lift gate engine is based on the lift gate load lifting capacity, wherein the higher the lifting capacity of the lift gate (e.g., in pounds), the higher the lift gate engine horsepower to enable sufficient hydraulic fluid pressure in the hydraulic manifold. An example operating range for a desired hydraulic fluid pressure in the hydraulic manifold of a lift gate may be about 500 pounds per square inch (PSI) to 4000 PSI depending on whether the lift gate is loaded or unloaded.

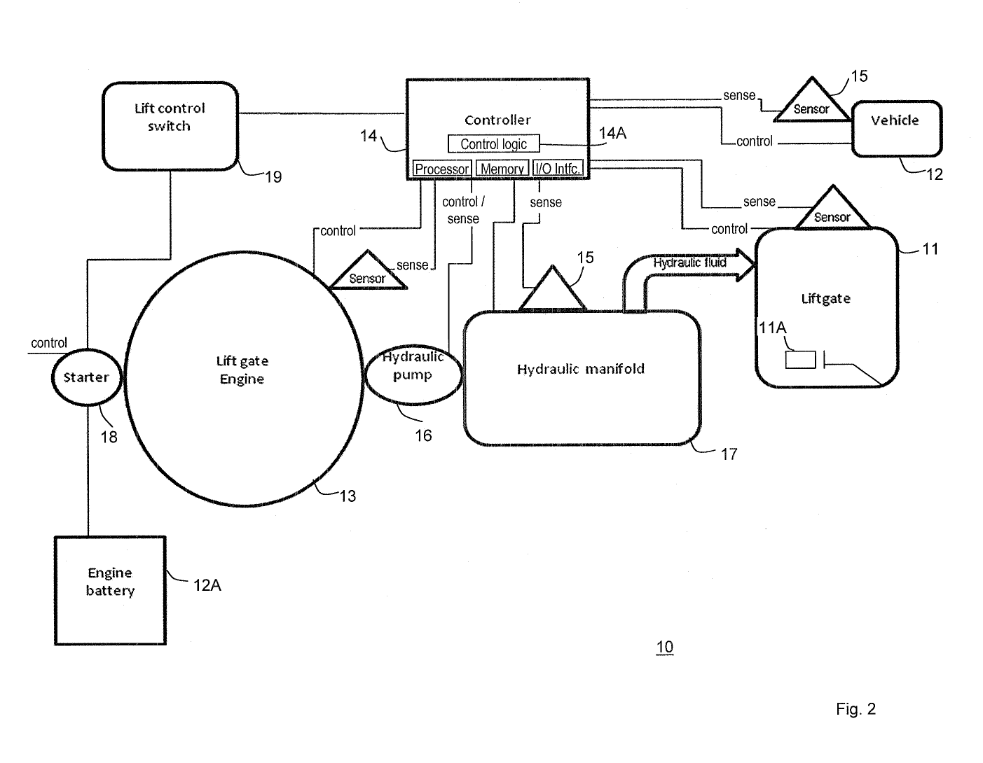

FIG. 2 shows a block diagram of an example implementation of the system of FIG. 1 for a lift gate with a hydraulic pump. Specifically, FIG. 2 shows a system 10 including a power system for a lift gate 11 for a vehicle 12, according to an embodiment of the invention. The power system includes a lift gate engine 13, a controller 14 and one or more sensors 15.

Using information from at least the sensors 15, the controller 14 controls operation of the lift gate engine 13 in providing power to a lift gate actuator system comprising a hydraulic pump 16 and hydraulic manifold 17. The power system alleviates the need for batteries to power the hydraulic pump 16.

The lift gate engine 13 drives the hydraulic pump 16 which moves hydraulic fluid in the hydraulic manifold 17. Hydraulic fluid is distributed from the manifold 17 to hydraulic actuators of the lift gate 11 that provide force for moving components of the lift gate. The lift gate actuator system may be of a conventional type.

The system 10 further includes a starter 18 for starting the engine 13, wherein the starter 18 can be powered by a battery such as the vehicle engine battery 12A (i.e., the same battery that starts the vehicle engine).

The engine 13 is started by the starter 18 when the lift control switch 19 is closed by an operator, indicating that the operator wishes to operate the lift gate (such as raise/lower the lift platform).

In one embodiment, the controller 14 can be shut off or eliminated wherein the engine 13 is started by the starter 18 when the lift control switch 19 is closed by an operator, indicating that the operator wishes to operate the lift gate (such as raise/lower the lift platform).

In a preferred embodiment, the engine 13 is started by the starter 18 when the lift control switch 19 is closed by an operator, wherein the controller 14 manages operation of the engine 13, such as by controlling the engine speed (RPM) based on sensed information as described in more detail below. The engine 13 may include an engine management module (EMM) that provides engine status information to the controller 14, and the EMM can receive signals from the controller 14 to control operation of the engine 13. The vehicle 11 may include a management module that provides vehicle status (e.g., vehicle transmission in park mode, etc). Further, the vehicle engine may include engine management module that provide vehicle engine information (e.g., vehicle engine running/off).

The controller 14 receives sensor information from one or more components of the system 10 using the sensors 15, and processes the sensed information using control logic 14A to provide management control signals to one or more components of the system 10.

In one example, the control logic 14A of the controller 14 implements a feedback processing loop that senses hydraulic fluid pressure in the manifold 17 and controls speed of the engine 13 and/or operation of the hydraulic pump 16, such that fluid pressure in the manifold 17 is maintained at a desirable level for proper operation of the lift gate actuator system. The desirable level of fluid pressure in the manifold may be a predetermined value provided by the manufacturer of the hydraulic components such as the hydraulic actuators.

The controller 14 may also provide control signals to other components of the system 10 such as the lift gate 11 and vehicle 12. For example, the controller 14 may signal the lift gate 11 to prevent raising/lowering the lift platform while fluid pressure in the manifold 17 is below a desirable level for proper operation of the lift gate.

The controller 14 uses sensor information (e.g., from sensor on the engine 13, from sensor on the hydraulic manifold 17) to determine status, and allows operation of the lift gate when certain conditions are met. For example, the controller 14 senses if the engine 13 is running, and if there is sufficient hydraulic fluid pressure available to operate the lift gate. If so, then the controller 14 activates valves that control movement of hydraulic fluid for operation of the lift gate 11. If the engine 13 is off, and the lift control switch 19 is closed by an operator, the controller 14 causes the starter motor 18 to start the engine 13, and allows the engine revolutions to come up to a certain speed (as sensed by a sensor) for driving the hydraulic pump 16 such that sufficient fluid pressure is generated in the manifold 17 (as sensed by a sensor) to properly operate the lift gate (such as lower/raise the platform).

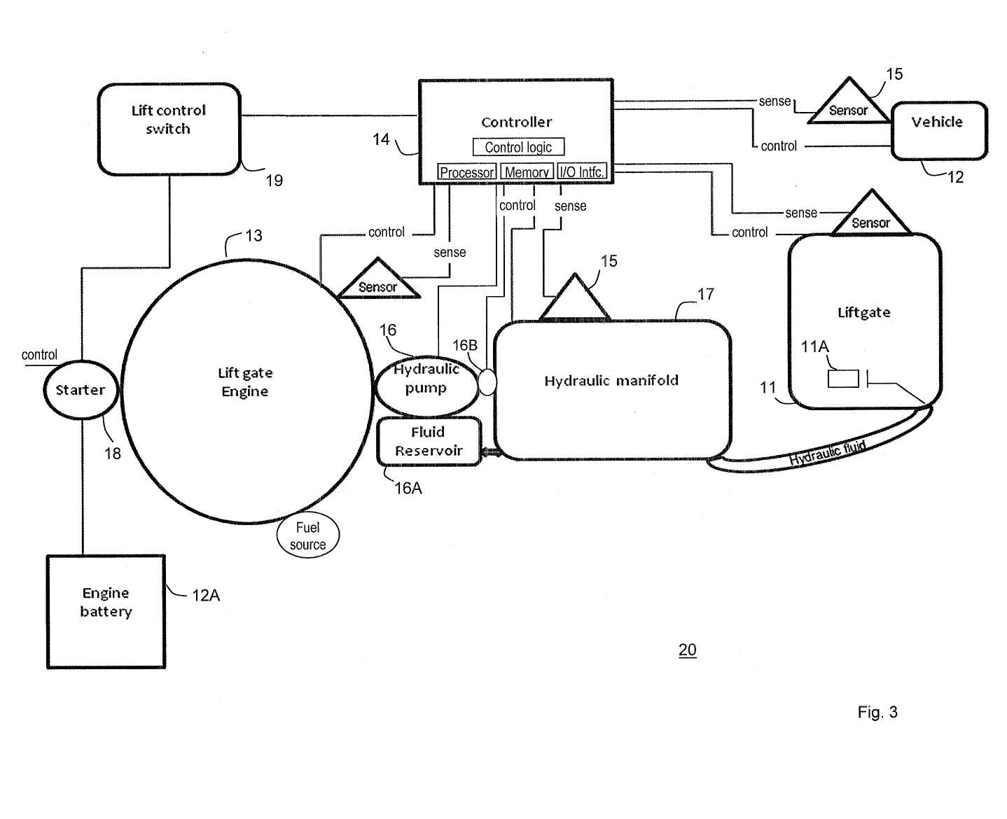

FIG. 3 shows a block diagram of another example implementation of powering a lift gate with a hydraulic pump, according to the invention. Specifically FIG. 3 shows a system 20 including a power system for a lift gate 11 on a vehicle 12, wherein power system 11 includes a lift gate engine 13, a controller 14 and one or more sensors 15. The controller 14 monitors and controls the lift gate engine 13 along with a hydraulic circuit powered by the lift gate engine 13, for proper operation of the lift gate 11.

Due to action of the pump 16 (as powered by the engine 13), the hydraulic fluid flows to the actuator 11A then returns to a reservoir 16A. The fluid is then re-pumped by the pump 16. The path of the hydraulic fluid is called a hydraulic circuit, as is known to those skilled in the art. The controller 14 starts the engine 13 to run the hydraulic pump 16 directly, waits for the engine 13 to reach a threshold revolutions per minute (RPM) as sensed by a sensor, then the controller 14 shifts a two-way valve 16B that allows fluid to enter the manifold 17 from the reservoir 16A. The controller 14 senses pressure build up in the manifold 17 to be above a threshold, before it sends a signal to allow operation of the lift gate such as raising the platform via a hydraulic actuator 11A.

The controller 14 may also sense fuel level for the engine 13 and generate a signal alerting an operator if the fuel level is too low and/or prevent operation of the lift gate since if the engine 13 may run out of fuel (leading to loss of hydraulic fluid pressure) in mid cycle of lift gate operation.

The controller 14 may also monitor pressure of the hydraulic fluid circuit (e.g., from the reservoir to the hydraulic actuator and back) when control switch 19 is engaged (e.g., to raise the lift gate platform). The pump 16 may comprise a regenerative pump in the hydraulic circuit, including a circulating valve system (i.e., inlet and outlet valves).

In one embodiment, the controller 14 monitors pressure sensors to sense pressure in the manifold 17, and when that pressure reaches a desired level, the control signals a valve to allow hydraulic fluid to flow from the manifold 17 to the lift gate actuator, for proper operation of the lift gate (e.g., to hold the lift platform up). In one embodiment, the controller 14 starts the engine 13 to run the hydraulic pump directly, then waits for the engine 13 to reach a threshold RPM as sensed by a sensor, then the controller 14 shifts a two-way valve that allows fluid to enter the manifold 17. The controller senses pressure build up in the manifold 17 to reach a desired level, before it allows operation of the lift gate such as raising the platform.

Using sensors, the controller 14 senses condition of the lift gate, such as if the platform is down or lift gate is stowed in the proper position, etc., before it allows shut down of the engine 13. The controller 14 may employ a feedback loop to control RPM speed of the engine 13 to maintain the engine RPM within a desired range for driving the pump 16, to allow sufficient hydraulic fluid pressure for proper operation of the lift gate, such as based on sensed pressure in the pump manifold. The controller 14 may receive input from the vehicle chassis indicating condition of the chassis (e.g., parked vehicle, not moving, level ground, etc.) before it allows the engine 13 to be started and/or the lift gate to be operated.

The controller 14 and sensors 15 form a system that automatically monitors various parameters in the system 10 (e.g., lift gate engine RPM, pump speed, fluid pressure in manifold 17, lift gate state/condition), and sends control commands to various components in the system 10 to enable proper operation of the lift gate by an operator.

The standalone engine 13 can be turned on to run the hydraulic pump 16 to operate the lift gate, and then turned off when the lift gate operation is completed. The vehicle engine need not be running to operate the lift gate or to charge batteries for running the lift gate.

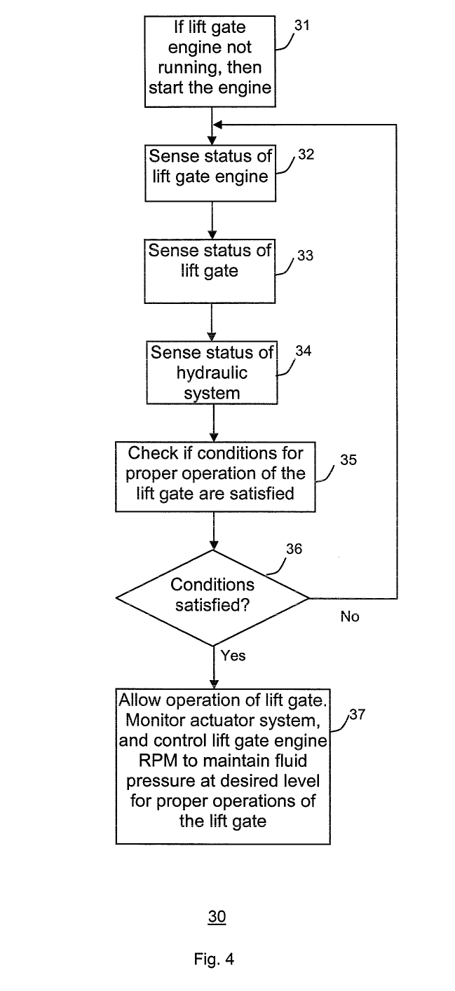

FIG. 4 shows a flowchart of a sense and control process 30 implemented by control logic 14A of the controller 14, according to an embodiment of the invention. The controller 14 receives notification that an operator desires to operate the lift gate 11 using the lift gate switch 19 (e.g., lower/raise the lift gate platform, fold/unfold the lift gate, etc.). This requires use of the actuator system including the hydraulic system. The control process 30 includes:
Block 31: If lift gate engine 13 is not running, then start the engine 13.
Block 32: Sense status of the lift gate engine 13 (e.g., RPM).
Block 33: Sense status of the hydraulic system (e.g., hydraulic pressure in the system).
Block 34: Sense status of lift gate 11 (e.g., platform up/down).
Block 35: Based on the sensed information, check if conditions for proper operation of the lift gate are satisfied.
Block 36: If the conditions are satisfied, then proceed to block 37, otherwise disable lift control switch 19 and repeat blocks 32-35 until the conditions are satisfied.
Block 37: Enable lift control switch 19 to allow operation of the lift gate. Monitor fluid pressure, and control engine RPM (i.e., send control signal to engine governor) to maintain fluid pressure at desired level for proper operation of the lift gate (e.g., increase engine RPM when demand for fluid pressure increases based on lift gate operation).

If the conditions are not satisfied, the controller may attempt to remedy the situation to satisfy the conditions. For example, if after waiting for a time period the fluid pressure remains below a threshold, the controller 14 may signal the engine 13 to increase RPM to raise the fluid pressure to the threshold.

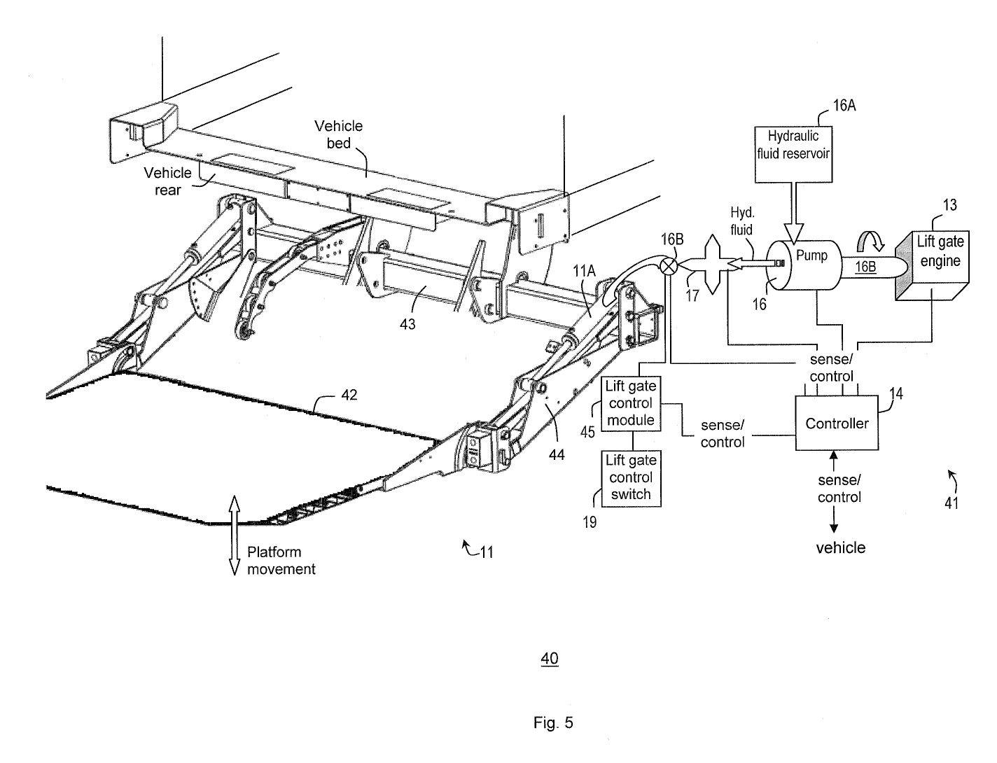

FIG. 5 shows an example system 40 comprising a lift gate 11 and power system 41, according to an embodiment of the invention. The lift gate 11 is attached to a vehicle (bed of truck, partially shown) and includes a platform 42 (shown in unfolded and lowered position) coupled to a support frame 43 via a lift linkage 44, wherein the platform 42 is capable of being moved (lowered/raised) by the actuator 11A via the lift linkage 44.

In this embodiment, the power system 41 comprises the above-described lift gate engine 13 and controller 14, wherein the lift gate engine 13 is coupled to the hydraulic pump 16 by a coupler 16B to directly drive the pump 16. The coupler 16A may comprise a rotating axle connected between crank shaft of the lift gate engine 13 and the pump 16, or may comprise a viscous coupling, etc. The pumping action of the pump 16 directs hydraulic fluid from the reservoir 16A to the manifold 17, and hydraulic fluid from the manifold 17 flows to the hydraulic actuator 11A using pipes/tubes.

The lift control switch 19 may comprise user operable interface such as buttons, levers, etc., for receiving operator commands for operating the lift gate (e.g., lower/raise platform, stow/unstow lift gate). The switch 19 may also include display/audio devices for providing the operator with information about one or more of the lift gate, the actuator system, the power system, etc.

The operator commands from the switch 19 are processed by a lift gate control module 45. The lift gate control module 45 maintains information (status) about certain operational parameters of the various components of the lift gate 11 (e.g., platform up/down, lift gate stowed/unstowed, actuator condition, temperature). The lift gate control module 45 can provide this information to the controller 14 as needed.

As described above, the power system controller 14 functions to ensure that the power system (e.g., lift gate engine and the actuator system) operates in a way to provide proper level of power to the lift gate as demanded by operation of the lift gate 11 from an operator. The control module 45 functions to ensure that the lift gate 11 itself is operated properly by an operator, and the controller 14 ensures proper operation of the power system in powering the lift gate 11.

The lift gate control module 45 controls operation of the lift gate based on certain operational parameters of the lift gate 11. For example, after powering on the control module 45, sensor data are obtained by the controller. Sensor data may include, for example, power supply voltages, electric current, cycle of the operation of the lift, and load on the lift, etc. The obtained sensor data are correlated/compared with parameters pre-stored in a memory of the control module 45.

Inputs received by the control module 45 from the operator switch 19 are processed and a determination is made as to whether the required conditions are satisfied. The determination may include, for example, comparing the operator input sequence with the stored sequence to determine whether the input sequence is correct, and the lift gate is within operation limits. If the conditions are satisfied, the operation of the lift gate is enabled. If one or more of the conditions are not satisfied, a warning message may be provided to the operator and the control module 45 further awaits instructions without enabling the motion of the lift gate.

In one example, the lift gate engine 13 may be installed in a housing mounted on a frame of the vehicle (e.g., under the vehicle bed) near the hydraulic system and coupled to the pump 16 to drive the pump 16 (e.g., via an axle, viscous coupling, etc.). The controller 14 may also be placed in said housing, or placed elsewhere on the vehicle, and connected to the various sensors 15, the engine 13, the lift gate control module 34, the lift gate control switch 19, the pump 16, etc., in a wired or wireless manner. The controller 14 may be powered by the vehicle electrical power system or have a dedicated power system.

In another embodiment, the invention provides a method of powering a lift gate by providing an actuator system including an actuator for a lift gate, and coupling a lift gate engine to the actuator system, wherein the lift gate engine is configured for generating kinetic energy from a fuel source to power the actuator system for operating the lift gate.

The lift gate may comprise a platform coupled to a support frame via a lift linkage, the platform capable of being moved by the actuator via the lift linkage. The method may further comprise dynamically sensing status of at least one of: the lift gate engine, the actuator system and the lift gate, and dynamically monitoring sensed status, and based on the sensed status controlling at least one of: the lift gate engine and the actuator system for operating the lift gate.

Controlling at least one of the lift gate engine and the actuator system for operating the lift gate, may further comprise: if the lift gate engine is not running, then starting the lift gate engine using a starter; based on the sensed status, check if conditions for proper operation of the lift gate are satisfied; if the conditions are satisfied, then allowing operation of the lift gate; and monitoring the actuator system, and controlling lift gate engine RPM to maintain the actuator system in an operating range for proper operations of the lift gate.

The actuator may comprise a hydraulic actuator and the actuator system further includes a hydraulic pump for pumping hydraulic fluid to the hydraulic actuator, wherein coupling a lift gate engine to the actuator system further includes coupling the lift gate engine to the hydraulic pump for directly driving the hydraulic pump to pump hydraulic fluid to the hydraulic actuator for operating the lift gate.

The method my further comprise monitoring hydraulic fluid pressure in the actuator system, and controlling lift gate engine RPM to maintain the hydraulic fluid pressure actuator system in a range for proper operations of the lift gate.

The method may further comprise dynamically monitoring sensed hydraulic fluid pressure in the actuator system and upon the hydraulic fluid pressure in the actuator system reaching a predefined level, generating a signal for opening a valve in the actuator system to allow hydraulic fluid to flow to the hydraulic actuator for moving the lift gate linkage.

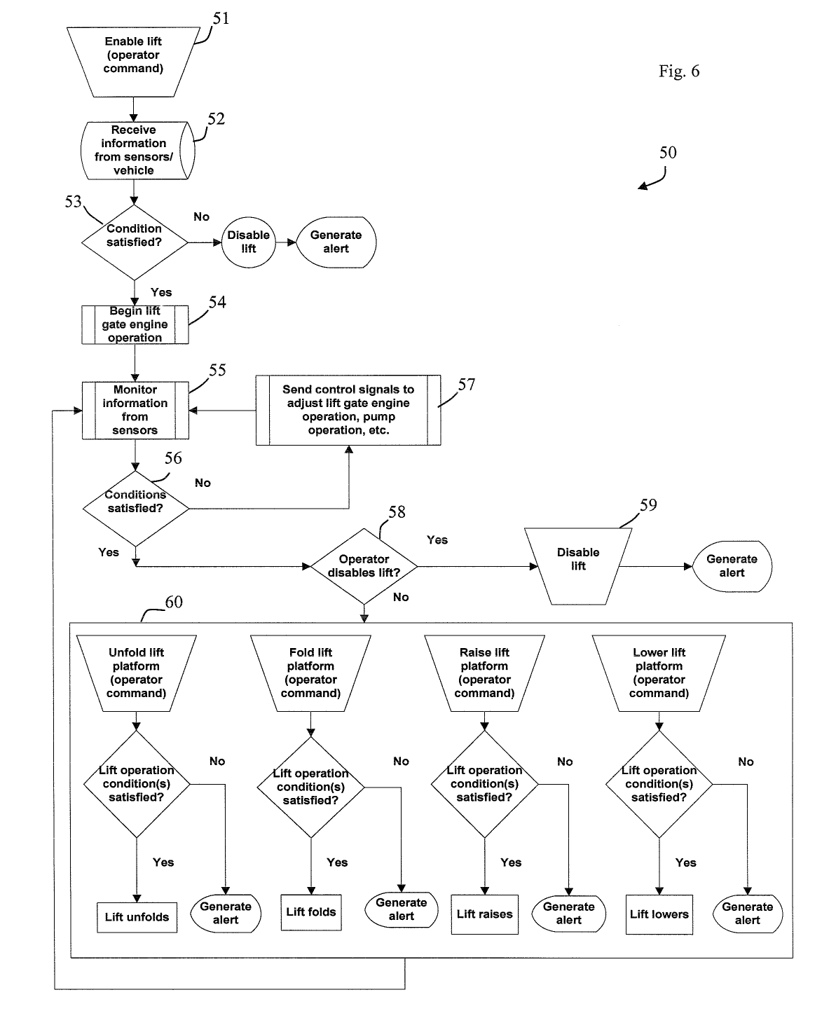

FIG. 6 shows a flowchart of a process 50 for operation of the lift gate power system and the lift gate, according to an embodiment of the invention, comprising the following process blocks:
Block 51: Receive operator command to enable lift gate for operation.
Block 52: Receive (gather) input from sources including lift gate sensors and/or vehicle components (e.g., vehicle parked status, parking brake status, vehicle transmission status, vehicle engine status).
Block 53: Determine if based on the received inputs primary lift gate operation conditions are satisfied (e.g., vehicle parked and parking brake set and vehicle transmission in park mode). If the primary lift gate operation conditions are satisfied, then proceed to block 54, otherwise, disable lift gate operation, generate alert to indicating lift gate is disabled.
Block 54: Begin lift gate engine operation (e.g., start the lift gate engine).
Block 55: Monitor lift gate power system via inputs from sources including sensors (e.g., hydraulic system status, hydraulic fluid pressure in manifold, engine speed, pump state).
Block 56: Determine if secondary conditions for operation of the lift gate are satisfied (e.g., hydraulic system operational, hydraulic fluid pressure in manifold at acceptable level, engine speed at desired level). If yes, proceed to block 58, otherwise proceed to block 57.
Block 57: Send control signals to the lift gate engine power system (e.g., lift gate engine) to adjust the lift gate power system to meet the secondary conditions for operation of the lift gate. Proceed back to block 55.
Block 58: Determine if operator wishes to disable lift gate or operate lift gate. If the operator wishes to disable lift gate, then proceed to block 59. If the operator wishes to operate the lift gate, then proceed to operation block 60.
Block 59: Disable lift gate (e.g., such lift gate engine off) and generate alert message.
Block 60: Perform lift gate operations based on operator commands, with the controller monitoring sensor information and making adjustments to lift gate power system (i.e., repeat process blocks 55-60).

The processing block 60 includes receiving operator commands for lift gate operation (e.g., unfold lift platform, fold lift platform, raise lift platform, lower lift platform). In response to each command, the controller determines if relevant lift gate operation conditions/parameters are satisfied. If so, then the controller allows execution of the received command, otherwise an alert may be generated. Process blocks 55-60 are repeated for the controller to ensure that the lift gate engine power system provides adequate and proper power output for proper lift gate operation, discussed above. The controller 14 may implement the above process 60 in conjunction with other controllers such as the lift gate control module 45, etc.

The present invention has been described in considerable detail with reference to certain preferred versions thereof; however, other versions are possible. Therefore, the spirit and scope of the appended claims should not be limited to the description of the preferred versions contained herein.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The embodiments of the controller 14, control module 45 and other controllers can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the embodiments of the controllers of the invention can take the form of a computer program product accessible from a computer-usable or computer-readable medium providing program code for use by or in connection with a computer, processing device, or any instruction execution system. For the purposes of this description, a computer-usable or computer readable medium can be any apparatus that can contain, store, communicate, or transport the program for use by or in connection with the instruction execution system, apparatus, or device. The medium can be electronic, magnetic, optical, or a semiconductor system (or apparatus or device). Examples of a computer-readable medium include, but are not limited to, a semiconductor or solid state memory, magnetic tape, a removable computer diskette, a RAM, a read-only memory (ROM), a rigid magnetic disk, an optical disk, etc. Current examples of optical disks include compact disk-read-only memory (CD-ROM), compact disk-read/write (CD-R/W) and DVD.

I/O devices (including but not limited to keyboards, displays, pointing devices, etc.) can be connected to the system either directly or through intervening controllers. Network adapters may also be connected to the system to enable the data processing system to become connected to other data processing systems or remote printers or storage devices through intervening private or public networks. Modems, cable modem and Ethernet cards are just a few of the currently available types of network adapters. In the description above, numerous specific details are set forth. However, it is understood that embodiments of the invention may be practiced without these specific details. For example, well-known equivalent components and elements may be substituted in place of those described herein, and similarly, well-known equivalent techniques may be substituted in place of the particular techniques disclosed. In other instances, well-known structures and techniques have not been shown in detail to avoid obscuring the understanding of this description.

The terms “computer program medium,” “computer usable medium,” “computer readable medium,” and “computer program product,” are used to generally refer to media such as main memory, secondary memory, removable storage drive, a hard disk installed in hard disk drive, and signals. These computer program products are means for providing software to the computer system. The computer readable medium allows the computer system to read data, instructions, messages or message packets, and other computer readable information, from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network that allow a computer to read such computer readable information. Computer programs (also called computer control logic) are stored in main memory and/or secondary memory. Computer programs may also be received via a communications interface. Such computer programs, when executed, enable the computer system to perform the features of the present invention as discussed herein. In particular, the computer programs, when executed, enable the processor or multi-core processor to perform the features of the computer system. Accordingly, such computer programs represent controllers of the computer system. The wireless protocol for communication between the various modules may comprise protocols such as IEEE 802.11, Bluetooth, Personal Area Network, control signals at different frequencies reflecting different tunable signals, FM, AM, packet communication, TCP/IP and other technologies which those skilled in the art recognize.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A power system for a lift gate, comprising:
an actuator system including an actuator for a lift gate; and
a lift gate engine coupled to the actuator system;
wherein the lift gate engine is configured for generating kinetic energy from a fuel source to power the actuator system for operating the lift gate.

2. The power system of claim 1, wherein:
the actuator comprises a hydraulic actuator and the actuator system further includes a hydraulic pump for pumping hydraulic fluid to the hydraulic actuator; and
the lift gate engine is coupled to the hydraulic pump for directly driving the hydraulic pump to pump hydraulic fluid to the hydraulic actuator for operating the lift gate.

3. The power system of claim 2 wherein:
the lift gate comprises a platform coupled to a support frame via a lift linkage, the platform capable of being moved by the actuator via the lift linkage.

4. The power system of claim 1 further comprising:
a controller module configured for monitoring a condition, and based on the condition controlling at least one of the lift gate engine and the actuator system for operating the lift gate.

5. The power system of claim 4 wherein the controller further comprises a feedback loop configured for dynamically monitoring the lift gate engine and generating a signal to control the operation of the lift gate engine for operation of the lift gate.

6. The power system of claim 5 wherein the controller module is further configured for dynamically monitoring the actuator system and the lift gate engine, and generating a signal for controlling operation of the lift gate engine such that the actuator system operation satisfies a predefined condition.

7. The power system of claim 6 further comprising:
a sensor system including an engine sensor for sensing operation of the lift gate engine;
wherein the controller is further configured for receiving engine sensor information and generating a control signal to maintain the lift gate engine within an operation range in powering the actuator system for proper operation of the actuator system for the lift gate.

8. The power system of claim 7 wherein the sensor system further comprises an actuator sensor for sensing operation of the actuator system;
wherein the controller is further configured for receiving actuator sensor information and generating a control signal to the lift gate engine for maintaining the actuator system within an operation range for proper operation of the lift gate.

9. The power system of claim 8 wherein the sensor system further comprises a lift gate sensor for sensing status of the lift gate;
wherein the controller is further configured for receiving lift gate sensor information and generating a control signal to at least one of the lift gate engine, the actuator system and a lift gate control module, for proper operation of the lift gate.

10. A lift gate system, comprising:
a lift gate including a platform coupled to a support frame via a lift linkage, the platform capable of being moved by an actuator via the lift linkage;
an actuator system including an actuator for the lift gate; and
a lift gate engine coupled to the actuator system;
wherein the lift gate engine is configured for generating kinetic energy from a fuel source to power the actuator system for operating the lift gate.

11. The lift gate system of claim 10, wherein:
the actuator comprises a hydraulic actuator and the actuator system further includes a hydraulic pump for pumping hydraulic fluid to the hydraulic actuator; and
the lift gate engine is coupled to the hydraulic pump for directly driving the hydraulic pump to pump hydraulic fluid to the hydraulic actuator for operating the lift gate.

12. The lift gate system of claim 11 further comprising:
a sensor system for sensing status of the system; and
a controller module configured for monitoring sensed status, and based on the sensed status controlling at least one of the lift gate engine and the actuator system for operating the lift gate.

13. The lift gate system of claim 12 wherein the controller module is further configured for dynamically monitoring sensed status of the actuator system and the lift gate engine, and generating a signal for controlling operation of the lift gate engine such that the actuator system operation satisfies a predefined condition.

14. The lift gate system of claim 13 wherein the sensor system includes an engine sensor for sensing operation status of the lift gate engine, an actuator sensor for sensing operation status of the actuator system, and a lift gate sensor for sensing status of the lift gate;
wherein the controller is further configured for receiving engine sensor information and generating a control signal to maintain the lift gate engine within an operation range in powering the actuator system for proper operation of the actuator system for the lift gate;
wherein the controller is further configured for receiving actuator sensor information and generating a control signal to the lift gate engine for maintaining the actuator system within an operation range for proper operation of the lift gate; and
wherein the controller is further configured for receiving lift gate sensor information and generating a control signal to at least one of the lift gate engine, the actuator system and a lift gate control module, for proper operation of the lift gate.

15. The lift gate system of claim 13 wherein the controller module is further configured for dynamically monitoring sensed hydraulic fluid pressure in the actuator system and sensed engine speed of the lift gate engine, and generating a signal for controlling operation of the lift gate engine such that hydraulic fluid pressure in the actuator system operation satisfies a predefined condition.

16. The lift gate system of claim 15 wherein the lift gate engine comprises an internal combustion engine.

17. A method of powering a lift gate, comprising:
providing an actuator system including an actuator for a lift gate; and
coupling a lift gate engine to the actuator system, wherein the lift gate engine is configured for generating kinetic energy from a fuel source to power the actuator system for operating the lift gate.

18. The method of claim 17 wherein:
the lift gate comprises a platform coupled to a support frame via a lift linkage, the platform capable of being moved by the actuator via the lift linkage.

19. The method of claim 18 further comprising:
dynamically sensing status of at least one of the lift gate engine, the actuator system and the lift gate; and
dynamically monitoring sensed status, and based on the sensed status controlling at least one of the lift gate engine and the actuator system for operating the lift gate.

20. The method of claim 19 wherein controlling at least one of the lift gate engine and the actuator system for operating the lift gate, further comprises:
if the lift gate engine is not running, then starting the lift gate engine using a starter;
based on the sensed status, check if conditions for proper operation of the lift gate are satisfied;
if the conditions are satisfied, then allowing operation of the lift gate; and
monitoring the actuator system, and controlling lift gate engine RPM to maintain the actuator system in an operating range for proper operations of the lift gate.

21. The method of claim 20, wherein:
the actuator comprises a hydraulic actuator and the actuator system further includes a hydraulic pump for pumping hydraulic fluid to the hydraulic actuator; and
coupling a lift gate engine to the actuator system further includes coupling the lift gate engine to the hydraulic pump for directly driving the hydraulic pump to pump hydraulic fluid to the hydraulic actuator for operating the lift gate;

22. The method of claim 21 further comprising:
monitoring hydraulic fluid pressure in the actuator system, and controlling lift gate engine RPM to maintain the hydraulic fluid pressure actuator system in a range for proper operations of the lift gate.

23. The method of claim 22 further comprising:
dynamically monitoring sensed hydraulic fluid pressure in the actuator system; and
upon the hydraulic fluid pressure in the actuator system reaching a predefined level, generating a signal for opening a valve in the actuator system to allow hydraulic fluid to flow to the hydraulic actuator for moving the lift gate linkage.

24. The method of claim 23 further including:
based on sensed lift gate engine status, generating a control signal to maintain the lift gate engine within an operation range in powering the actuator system for proper operation of the actuator system for the lift gate;
based on sensed lift gate actuator system status, generating a control signal to the lift gate engine for maintaining the actuator system within an operation range for proper operation of the lift gate; and
based on sensed lift gate status, generating a control signal to at least one of the lift gate engine, the actuator system and a lift gate control module, for proper operation of the lift gate.

25. The method of claim 17 wherein the lift gate engine comprises a diesel engine.
